(19) United States
(12) Patent Application Publication
(10) Pub. No.: US 2024/0300754 A1
(43) Pub. Date: Sep. 12, 2024

(54) CONE DISPENSING APPARATUS AND METHOD THEREOF

(71) Applicants: Chris MARTIN, Brownsburg, IN (US); INTERBAKE FOODS LLC, BROWNSBURG, IN (US)

(72) Inventor: Chris Martin, Brownsburg, IN (US)

(73) Assignee: INTERBAKE FOODS LLC, BROWNSBURG, IN (US)

(21) Appl. No.: 18/551,546

(22) PCT Filed: Mar. 21, 2022
(86) PCT No.: PCT/US22/21207

§ 371 Date: Sep. 20, 2023

Related U.S. Application Data
(60) Provisional application No. 63/163,070, filed on Mar. 19, 2021.

(51) Int. Cl. B65G 59/10; A23G 7/00; A23G 9/14; A23G 9/28

(52) U.S. Cl. CPC B65G 59/107; A23G 7/0025; A23G 9/14; A23G 9/288

(57) ABSTRACT

A cone dispensing apparatus a control system for monitoring and controlling the various components of the apparatus. The dispensing apparatus can include a first cam and a second cam, wherein the first cam and second cam are positioned parallel to each other in a housing. A first motor can be coupled to the first cam and a second motor can be coupled to the second cam, wherein the first and second motors are configured to rotate the cams around an axis. A first holdback plate and a second holdback plate can be coupled to a respective first linear motor and second linear motor. The hold back plates and cams can be synchronized to dispense a cone from the cone stack to the cams positioned below.

### FIELD OF THE INVENTION

This U.S. Patent Application Patent application claims priority to U.S. Provisional Application 63,163,070 filed Mar. 19, 2021, the disclosure of which is considered part of the disclosure of this application and is hereby incorporated by reference in its entirety.

### FIELD OF THE INVENTION

This disclosure relates generally to a comestible product dispensing apparatus. In one aspect, the present disclosure relates to a dispensing apparatus for cone-like structures, in particular ice-cream cones.

### BACKGROUND

In the comestible and ice cream industry, it is known a destacking device, in particular, for ice-cream production in which conically rolled comets or ice-cream wafers (referred to herein below as “cones” for short) are filled, in an ice-cream-filling machine, with the flavors of ice-cream envisaged therefore and are provided with suitable packaging. Known ice-cream-filling machines operate cyclically, in which case so-called trays or placards are provided transversely to the running direction of the ice-cream-filling machine. In this case, the holders of a tray are first filled in each case with a conical wafer which is provided to receive and package the portion of ice cream which is to be produced. Cones then have to be carefully positioned at the same time in the conical packaging units. A chain conveyor then intermittently transports the tray or placards and processes it further, in particular to fill the cones with one or more layers of the same or different flavors of ice-cream and then provides it with a closure cover.

Destacking devices are required for the abovementioned positioning of cones in the holders of a tray. Stacks of wafer cones inserted one inside the other are introduced manually in each case into the magazines of the destacking machine. From each stack, the lowermost cone then has to be separated and set down as carefully as possible in the associated holder of the tray which is to be filled. The performance requirements are at least around 30 to 60 cycles per minute and a reject rate (breakage) of less than or equal to one per thousand. Furthermore, the destacking device has to be capable of processing relatively large tolerances of the cones since these products are products made of natural ingredients which can also swell as a result of moisture absorption.

As the cones are very fragile, the above-mentioned requirements are very difficult to achieve. Various destacking devices available in the trade, for example, as described in U.S. Pat. No. 3,923,200, operate with rigid metallic grippers, which may comprise holding pins that retain the stack of cones and allow the lowermost end cone to drop when the tray holder is located beneath it. The gripping jaws are usually made of metal and protected by a soft material. In addition, the jaws have a small surface in contact with the wafer and they are not provided with a wafer or conical shape. In addition, they can present a hygienic risk. Also, the dropping action here results in a relatively high reject rate. Furthermore, there are problems with the centering of the cones in the holders. The motion of the grips is generally rotational, and the mechanical assembly is rather complicated. An alternative to rigid metallic jaws is proposed ins U.S. Pat. No. 7,036,682. This mechanism is of medium complexity and the reject rate is less.

In view of these disadvantages, improvements in such devices are desired and some particularly useful improvements are disclosed by the present invention. There exists a need to for an improved apparatus for placing cones into packaging and placards and dispensing for potentially being packaged or filled by an ice cream dispensing apparatus.

### BRIEF SUMMARY OF THE INVENTION

In one aspect, this disclosure is related to a cone dispensing apparatus a control system for monitoring and controlling the various components of the apparatus. The dispensing apparatus can include a first cam and a second cam, wherein the first cam and second cam are positioned parallel to each other in a housing. A first motor can be coupled to the first cam and a second motor can be coupled to the second cam, wherein the first and second motors are configured to rotate the cams around an axis. A first holdback plate and a second holdback plate can be coupled to a respective first linear motor and second linear motor. The hold back plates and cams can be synchronized to dispense a cone from the cone stack.

In some exemplary embodiments, a single motor can drive both cams utilizing timing belts and gearing to synch the cams for dispensing the cones. Similarly, a single motor can drive both the first and second hold back plates utilizing one or more brackets and gearing. The single motor can allow for both hold back plates to move together in equal but opposite directions to a second position, but back to a first position. The motors can include but are not limited to pneumatic and servo linear actuators among others.

In another aspect, this disclosure is related to a method of dispensing a cone utilizing the apparatus of the present disclosure. In one exemplary embodiment, two rotary actuators or motors can index or rotate two cam shafts in equal but opposite directions to drop a single cone from each stack of cones with each index or 180 degrees of rotation. During operation, the cams open wide enough for the cones to drop through. A lip/separator on each cam also can press the rims of the cones to separate them from the next cone on top of the current cone. A second pair of actuators holds the cone stacks back from falling when the cam is in the open position. These actuators are a pair of opposing linear actuators. The actuators move open the holdback plates when the cams are in the closed position allowing the stacks of cones to lower into the cam. The actuators then cause the plates to move into a closed position prior to the cams indexing to and open position and dropping the next cone out of the dispensing apparatus.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a perspective view of an exemplary embodiment of the dispensing apparatus of the present disclosure.

FIG. 2A is a perspective view of an exemplary embodiment of the dispensing apparatus of the present disclosure having a cone support assembly.

FIG. 2B is a perspective view of an exemplary embodiment of the dispensing apparatus of the present disclosure with the cone support assembly removed.

FIG. 2C is a top view of an exemplary embodiment of the dispensing apparatus of FIG. 2B.

FIG. 2D is a top view of an exemplary embodiment of the dispensing apparatus of FIG. 2C with the finger assembly removed.

FIG. 3 is a cross-section view of an exemplary embodiment of the cone dispenser of the present disclosure along axis A from FIG. 2C.

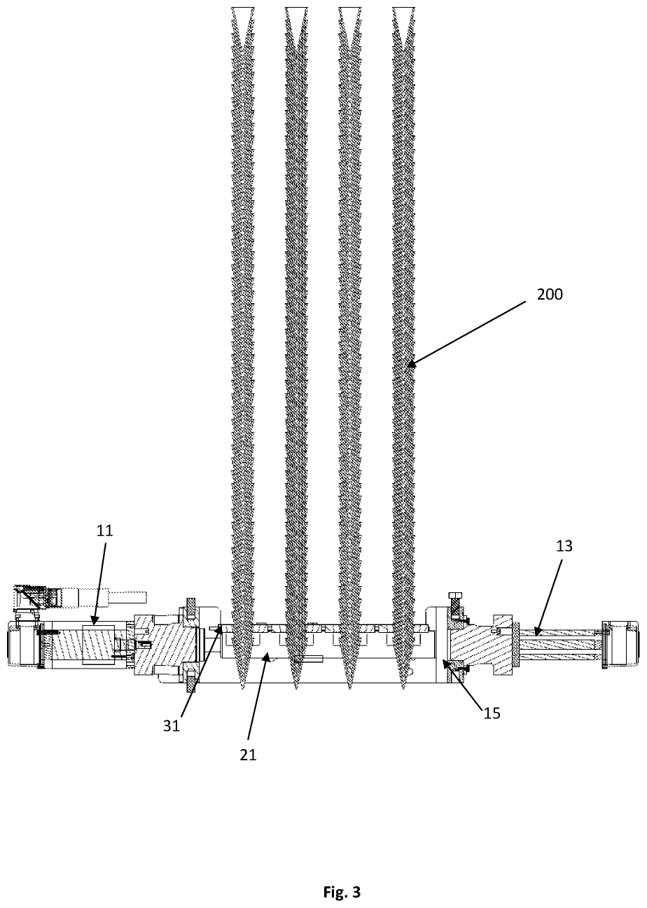

FIG. 4 is a cross-section view of an exemplary embodiment of the cone dispenser of the present disclosure along axis B from FIG. 2C where the cams are in a closed position.

FIG. 5A is a perspective view of cams from an exemplary embodiment of a dispensing apparatus of the present disclosure where the cams are in an open position.

FIG. 5B is a perspective view of a double cam mechanism of an exemplary embodiment of a cone dispensing apparatus of the present disclosure in an open position with cones shown in each cone cavity of the cams.

FIG. 5C is a cross-section of the cams a cone dispensing apparatus of the present disclosure along axis C of FIG. 5B.

FIG. 5D is a perspective view of a double cam mechanism of an exemplary embodiment of a cone dispensing apparatus of the present disclosure in a closed position with cones show in each cone cavity of the cams.

FIG. 5E is a cross-section of the cams a cone dispensing apparatus of the present disclosure along axis C of FIG. 5D.

FIG. 6 is a perspective view of a cone loading apparatus including a dispensing apparatus of the present disclosure.

FIG. 7 is a block diagram of the control system of a dispensing apparatus of the present disclosure.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being in communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

In some exemplary embodiments, the apparatus of the present disclosure can include a control system that can include a microprocessor having random access memory, read only memory, input ports, real time clock, output ports, and a controller area network (CAN) port for communicating to systems outside of the battery pack as well as to communicatively couple monitoring devices and other battery pack modules.

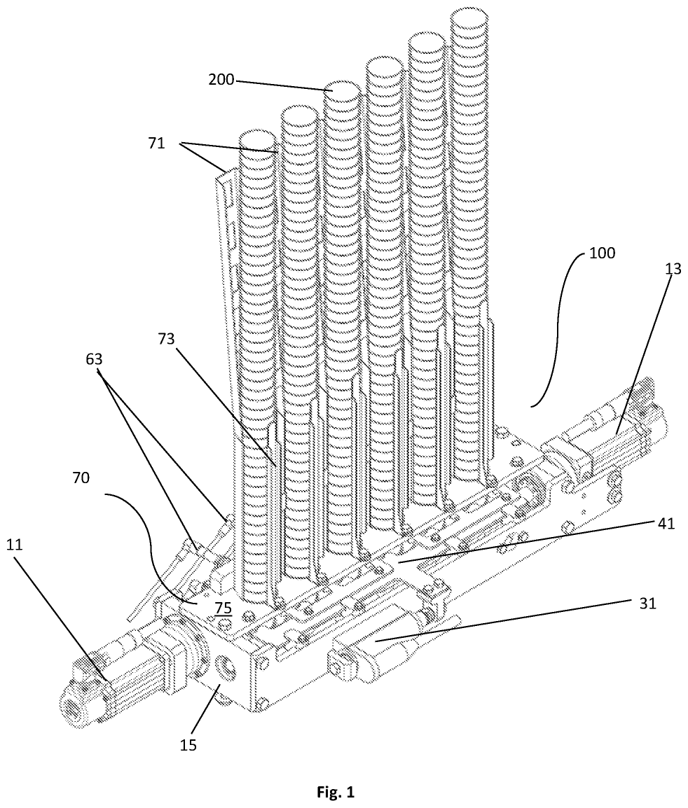

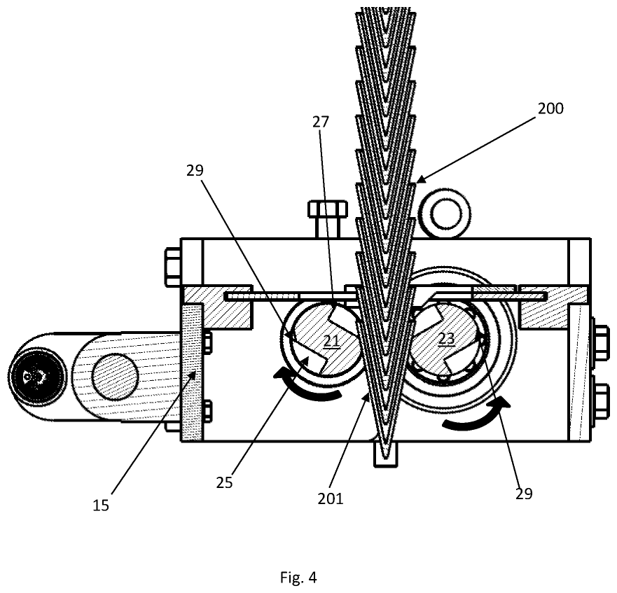

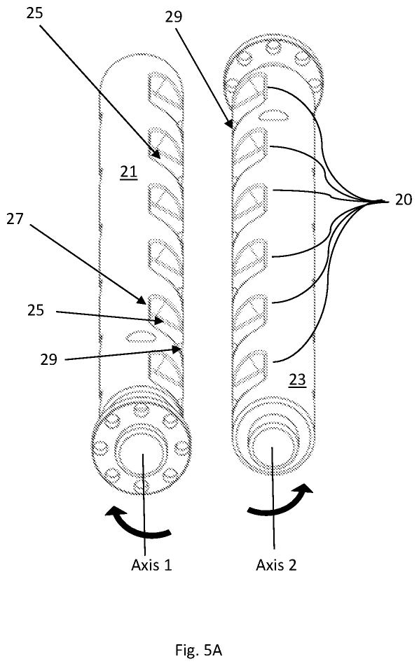

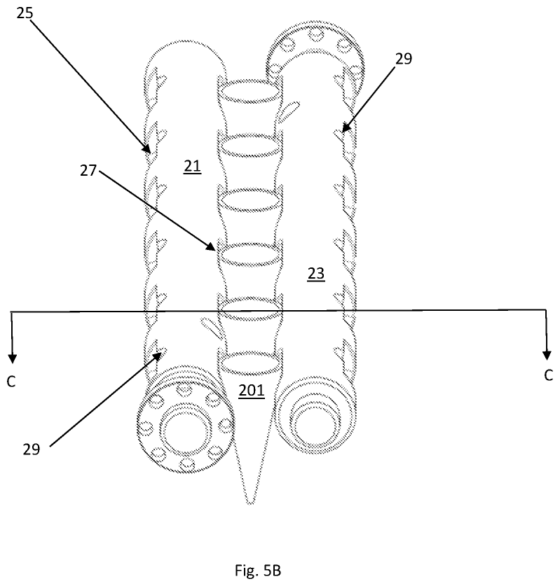

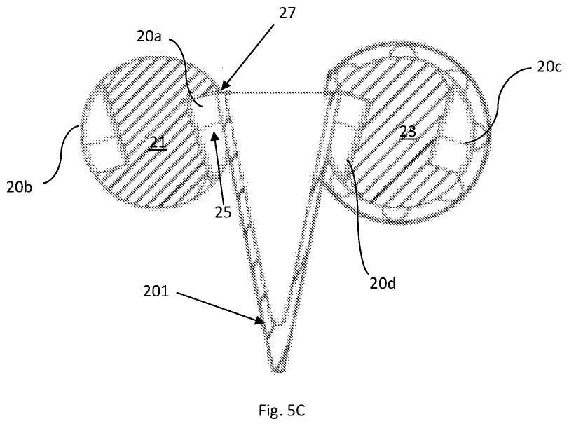

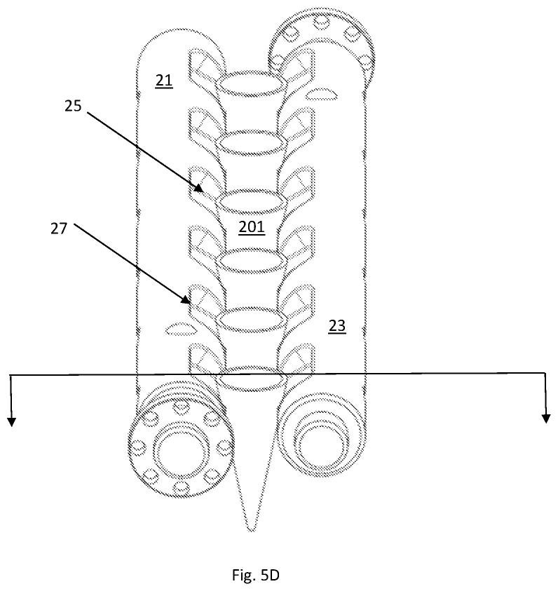

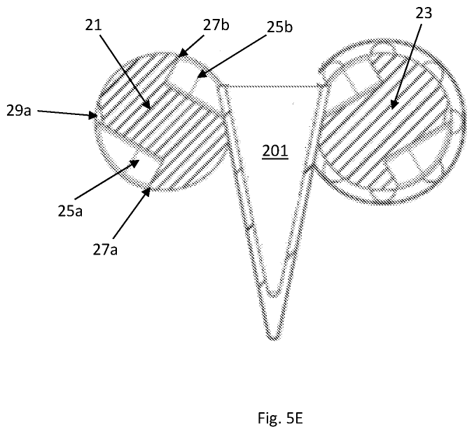

Exemplary embodiments of the apparatus of the present disclosure can include one or more rotary actuators. As shown in FIG. 1, an exemplary embodiment of the comestible product destacking or dispensing apparatus can include a first rotary actuator 11 and a second rotary actuator 13. The rotary actuator can be any suitable actuator including a servo motor. In some exemplary embodiments, a first linear actuator 31 and second linear actuator 33 can be mounted to one or more housing members 15 and positioned relatively across from each other. In some exemplary embodiments, the first rotary actuator 11 can be coupled to a first rotary cam 21 and a second rotary cam 23. The first rotary actuator 11 when engaged can rotate the first rotary cam 21 along a first axis in a first direction around the respective axis as shown FIG. 5A. Similarly, the second rotary actuator 13 when engaged can rotate the second rotary cam 23 along a second axis in a second direction around the respective axis as shown in FIG. 4-5. In some exemplary embodiments, the first and second direction can be the same rotational direction along the cam axis. In other exemplary embodiments, the first and second direction can be the opposite rotational direction along the cam axis. The various actuators and motors can be mounted to the housing 15, the cams can be positioned within the housing.

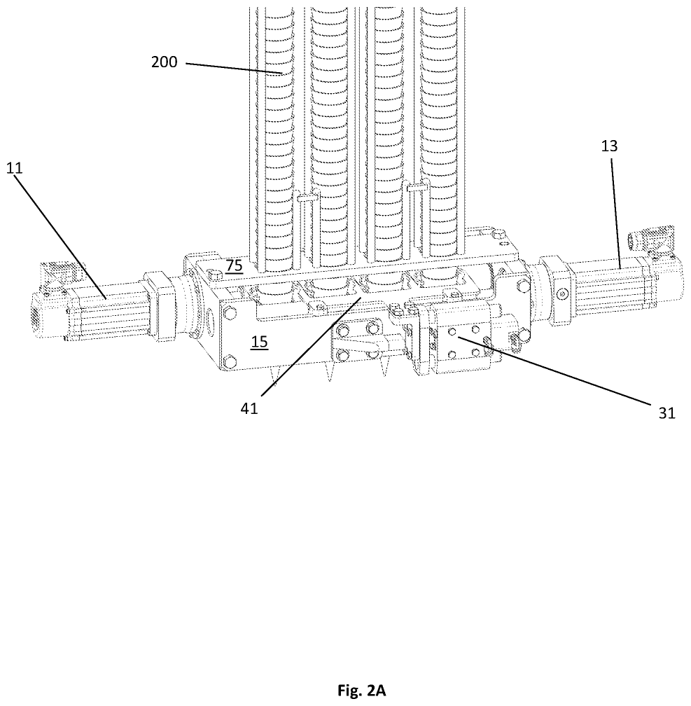

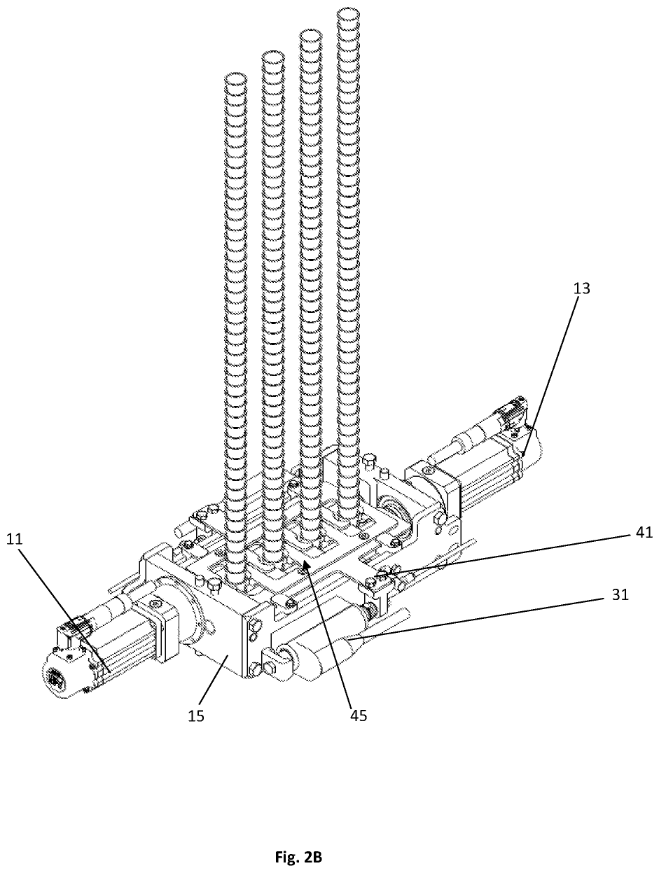

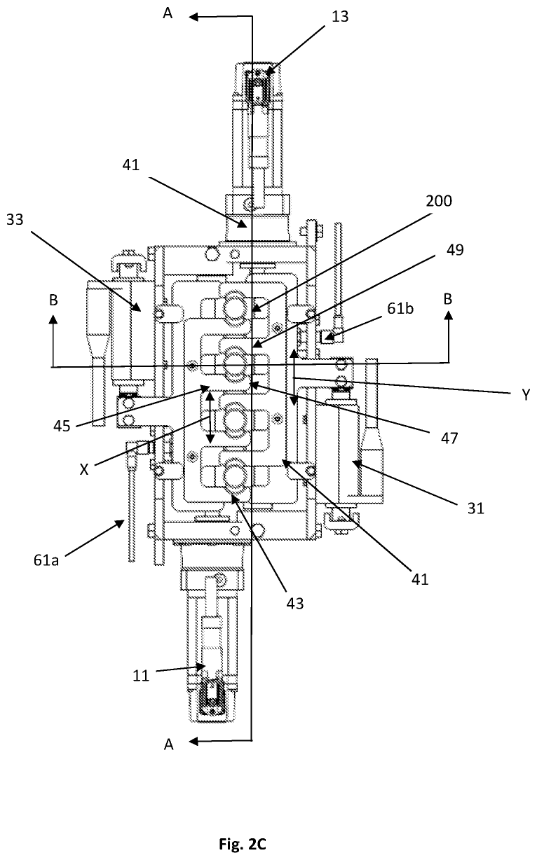

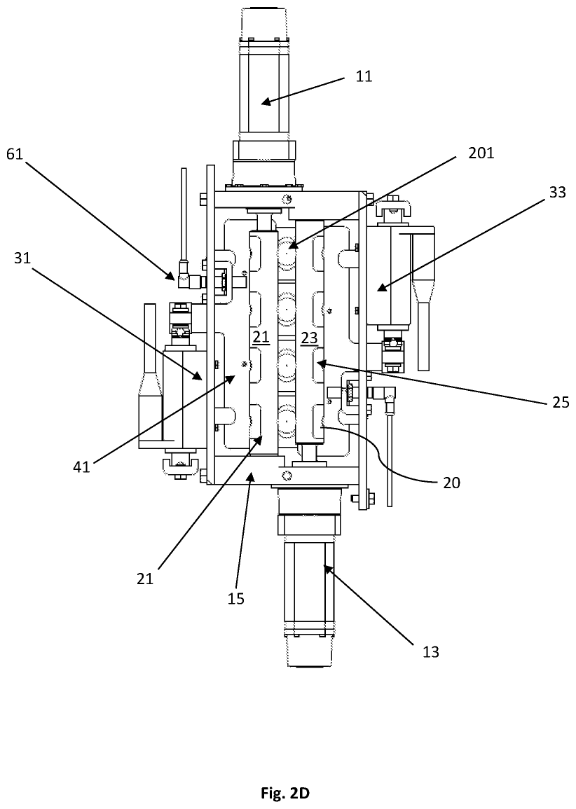

Additionally, one or more linear actuators 31, 33 can be coupled to the housing member 15. A first holdback finger plate 41 can be coupled to a first linear actuator 31. A second holdback finger plate 43 can be coupled to a second linear actuator 33. The actuators can move the respective holdback finger plates along a respective horizontal axis (X,Y) as shown in FIG. 2C. Each of the holdback finger plates 41,43 can include a finger assembly which can include a first portion 45. One or more finger portions 47 can extend generally perpendicularly from the first portion 45. In some exemplary embodiments, at the distal end of the finger portion, the plates can have a grip portion 49. In some exemplary embodiments, the finger assembly can be incorporated into the finger plate or can alternatively be a removeable portion of the holdback finger plates. As shown in FIG. 2C, the grip portion 49 can take any suitable shape include a concave or recess that conforms the shape of a cone. The linear actuators 31,33 can activate to move the respective plates 41, 43 from a first position to a second position along the respective horizontal axis. In the first position, the finger portions 47 can be positioned to contact a cone 200 of the cone stack 201.

When moved into a second position, the finger portions 47 can be moved away from the cone stack to allow the stack to advance the next cone in the dispenser. The top plates 41,43 can be configured to move in opposite horizontal directions from each other in order to disengage the cone or moved towards each other to engage the cone 201. As the plates move along their respective axis plane, the finger portions similar move thereby engaging and disengaging the cone stacks. The cones can then be dropped below to the cams positioned below the top plates.

One or more cam homing indexing sensors 61 can additionally be used in the dispensing apparatus of the present disclosure. The one or more sensors 61 can be used to monitor the indexing of each cam and the position of the cams during the operation and dispensing of the cones. The sensors 61 and actuator can also be communicatively coupled to the control system 700. Additionally, the system 100 can further include a cone presence sensor 63. The cone presence sensor 63 can determine if a cone is positioned within the apparatus for each of the stack openings and inform the control system when to actuate the next cycle to advance the cam cycle to drop the cones into the placard 600 below. This ensures that all the cones are provided to the designated row of the placard below. The cone presence sensor 63 can be any suitable sensor, including but not limited to a proximity sensor, IR break sensor, fixed focus photoelectric diffuse sensor, optical sensor, or any other suitable sensor.

As shown in FIG. 1, the apparatus 100 can further include a cone supporting apparatus 70 which can include a cone supporting member 71 or dispenser drive mount plate. The cone supporting apparatus can be located above the cam indexing portion and holdback members 41,43 so as to align the cone stacks with the fingers and dispensing portions of the cams. Similarly, the supporting apparatus 70 can be mounted to the housing 15. The cone supporting assembly 70 can include a cone supporting member 71 can include one or more stack support members 71 that extend vertically from the support base plate 75 of the cone supporting member to provide support to the stack of cones to be dispensed. In some exemplary embodiments, a portion of support members can be formed at an angle relative to the bottom portion of the support member 71. Optionally, a secondary support member 73 or cone stack retainer can be positioned opposite the primary support member 71 or cone hopper. The two support members can ensure the cones stacks are maintained as cones are dispensed from the apparatus. The support member 71 and secondary support member 73 can be positioned proximate to the cones to further limit movement of the cone stacks as cones are being dispensed.

As shown in FIGS. 4 and 5, the cams can have various numbers of dispensing portions 20 which can include a cone receiver portion 25, a cone separator portion 27, and a cone sweep portion. In some exemplary embodiments, the cone receiver portion 25 can be a void or space to allow for the cone 201 into position and then dispensed to a tray or placard 600. In some exemplary embodiments, the cone separator portion 27 can be a notch that can engage the top edge of a cone 201 allowing the cone to be separated from a cone stack 200. Dispensing portions 20 can be located on alternate sides of a cam to allow for a full rotation of the cam to allow for two cones to be dispensed per one full rotation.

In one exemplary embodiment, two rotary actuators 11, 13 can index 180 degrees together spinning a set of one or more dispensing portion for each respective cam 21, 23 in equal but opposite directions to drop a single cone 201 from each stack 200 of cones with each index. A single 360-degree rotation of the cams can result in two cones being dispensed per stack. In some exemplary embodiments, each cam can have two receiver portions 25, sweep portions 29, and separators portions 27 located on opposite sides of the cam shaft surface to enable for the dispensing of two cones per 360-degree rotation. During operation, the cams 21,23 can be open wide enough for the cones to drop through an aperture to the rotary cam portion of the apparatus. A lip/separator 27 on each cam also can press the rims of the cones to separate them in the event that a cone is stuck to the cone above in the cone stack.

A second pair of actuators can hold the cone stacks back from falling when the cam is in the open position. These actuators are a pair of opposing linear actuators 31,33. In some exemplary embodiments, the various elements such as the cams 21,23 and or holdback plates 41,43 can be powered by servo electric actuators and/or pneumatic actuators or a combination of each. The actuators can be in the open position when the cams are in the closed position allowing the stacks of cones to lower into the cam as shown in FIG. 5D. The actuators then cause the plates 41,43 to move into a closed position prior to the cams indexing to an open position shown in FIG. 5B and dropping the next cone out of the dispensing apparatus. There can be any number of stacks from one stack up to the machining limitations of the dispenser cam shaft. FIG. 1 provides a six-stack exemplary embodiment of a dispensing apparatus of the present disclosure, while FIGS. 2A-D provide a 4-stack assembly is provided, but designs can include any number of stacks desired. Similarly, the size of the cones for each stack can vary to allow for multiple types of cones to be dispensed. In some exemplary embodiments, the cone dispensing apparatus can be modified to adjust for use with various cone sizes by switching out the cams to ensure the cam sizes correspond to the cone size to be dispensed.

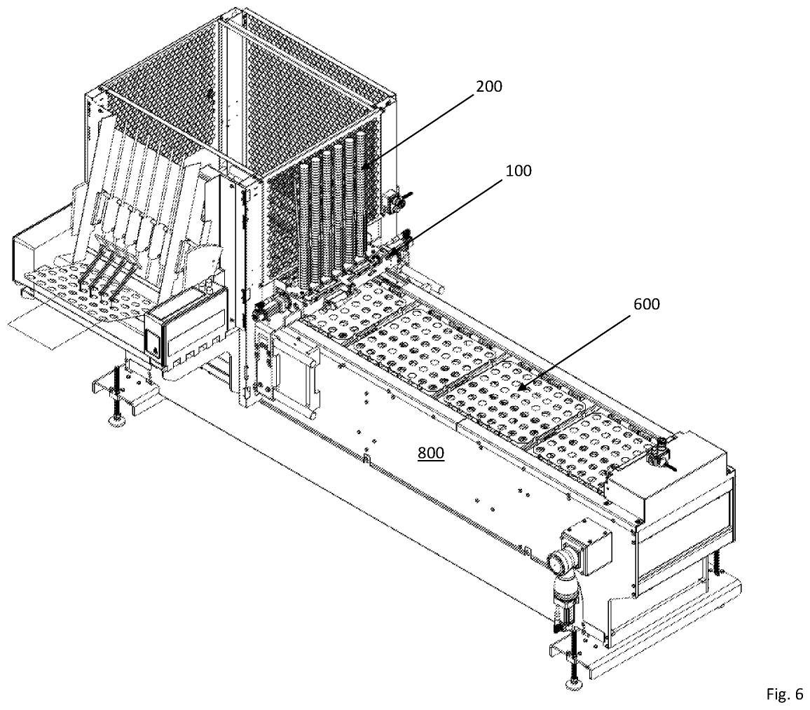

Additionally, some exemplary embodiments of a dispensing apparatus of the present disclosure can be configured to dispense 1-12 cones at a time from 1-12 separate stacks of cones but could be modified to accommodate for more cones if desired. The number of cones dispensed varies depending on the size of cone used and is scalable in length. Cones can be loaded by hand into the stacks. Alternatively, cones can be conveyed through a conveying means into the stacks in order to allow for continuous dispensing of the cones by the dispensing apparatus. Similarly, in some exemplary embodiments, a conveyor means can receive the cones from an oven or other apparatus and transport the cones to the cone dispensing apparatus of the present disclosure. The conveyor means can be designed to interface with the cone dispensing apparatus and drop the cones in the various stacks or into placards that the conveyor means. After the cones are dispensed into the cone dispensing apparatus, they can then be dispensed into placards 600 which can then be packaged for transport using another packaging apparatus as shown in FIG. 6 or straight into a dispenser or transported using a separate conveying/transport means 800. Alternatively, the cones can similarly be dispensed into any suitable means and/or similarly dispensed to be filed by an ice cream dispenser or other dispensed product into the cone.

Alternative loading methods can be utilized to transport cones into the stacks for further dispensing. In some exemplary embodiments, the dispensing apparatus can include four driving devices, such as actuators, servo motors, pneumatic actuators, or mechanically driven apparatus to rotate the cams or actuate the holdback plates. In one exemplary embodiment, the apparatus can include four actuators involved in separating and dispensing the cones. Two of the actuators can be guided linear air cylinders. These operate in opposing directions to grab the second cones from the bottom in the stacks and hold them back as the bottom cones are dispensed. The other two actuators can be opposing cams driven by servo motors. The cams are designed and can be rotated on a 360-degree axis on a 180-degree Cone dispensing indexing cycle. The cams can have a receiver position 25 at each index that consists of a conical sweep 29 that matches the cones geometry. These actuators can hold in this position until the linear actuators have extended to hold back the stack of cones, then the cams will index to the next position. While indexing, a lip/separator portion 27 on the cam will push the rim of the bottom cone 201 down in the event that it is stuck to the cone above it. These actuators can rotate a full 360 degrees around their respective axis as shown in FIGS. 4 and 5A, and 180 degrees until the next receiver index at which point, the linear actuators will open, allowing the cone stack 200 to drop into the receiver for the next cycle. This indexing allows for a cone dispensing portion to dispense a cone per 180 degrees of rotation or alternatively, where the two corresponding cone dispensing portions on either side of the cam to dispense two cones in total per 360 degrees of rotation. In some exemplary embodiments, a first set of one or more dispensing portions of a first cam can be in a first index cycle with a first set of one or more dispensing portions of the second cam, and the second set of dispensing portions of a first cam can be configured to be in a second index cycle with the second set of dispensing portions of a second cam. These corresponding indexing cycles can be in any suitable rotational degrees, such as a 90-degree rotational index, a 180-degree rotational index cycle, or a 360-degree rotational index cycle, or any other suitable rotational index cycle. As shown in FIGS. 5A-5E, one exemplary embodiment can have a 180-degree rotational index cycle.

As shown in FIGS. 4-5, the cams can include simultaneously cone receiver portion 25 and the cone separator portions 27 synched to allow for the cams to allow for the apparatus to dispense the cones 201 from the cone stack 200. The aforementioned sensor 61 can monitor the positions and communicate to the control system 700 to determine if the cams are properly synched or if the one or more of the actuator speeds need to be adjusted to ensure the cams are properly synced for dispensing of the cones 201. Additionally, the control system 700 can monitor the linear actuators or motors for the holdback finger plates to ensure they are properly synched with the cams. Additional sensors can be utilized and included for monitoring the cone stacks, such as orientation, cone size, cone amount, and presence of the cones in every stack. FIG. 4 illustrates a first cam 21 and second cam 23 within the dispensing apparatus and shows the rotational direction of each of the cams of an exemplary embodiment of the dispensing apparatus of the present disclosure.

A first cam 21 can rotate around a first axis (Axis 1) and a second cam can rotate around a second axis (Axis 2) as shown in FIG. 5A. FIG. 5B illustrates a first cam 21 and a second cam 23 rotating around their respective axis in an open position to allow for the cones to be dispensed. A lip separator 27 can aid in separating the respective cone 201 from the cone stack 200 as a cam is rotated around the cams respective axis. A receive portion 25 in the open position allow for the cone to fall and/or be dispensed as further illustrated in FIG. 5C. Each cam can have a plurality of dispensing portions 20 on one or more sides of the respective cam. FIGS. 5A-5E illustrate exemplary embodiments with each cam having a plurality of dispensing portions. As shown in some exemplary embodiments, a cam can have a first set of dispensing portions that are positioned on a first side of the cam and a second set of dispensing portions on the alternate or opposite side the first set of dispensing portions of the cam. It should be understood that the cams can include any number of desired amount of dispensing portions depending upon quantity and cone size. Additionally, each cam can have a first set of dispensing portions and a second set of dispensing portions. In one exemplary embodiment, a first cam 21 can have first cone dispensing portion 20a and a second cone dispensing portion 20b. The first cone dispensing portion 20a can be positioned on the opposite side of the second cone dispensing portion 20b (FIG. 5C). A second cam 23 has a third cone dispensing portion 20c and the fourth cone dispensing portion 20d. The third cone dispensing portion 20c can be positioned on the opposite side of the fourth cone dispensing portion 20d.

Cams 21,23 when in a closed position, as shown in FIG. 5D prevent the cone from being dispensed until the cams rotate around their respective axis. FIG. 5E provides an illustration of a cross-section of the cams 21,23 with a set of dispensing portions in a closed position as they interface with a cone from a cone stack as well as the dispensing portions positioned on either end of the cam. The sensors 61 can monitor the position of the cams and or the respective dispensing portion 20 of each of the cams to ensure they are properly indexed with respect to each other for dispensing the cones from the respective stacks properly.

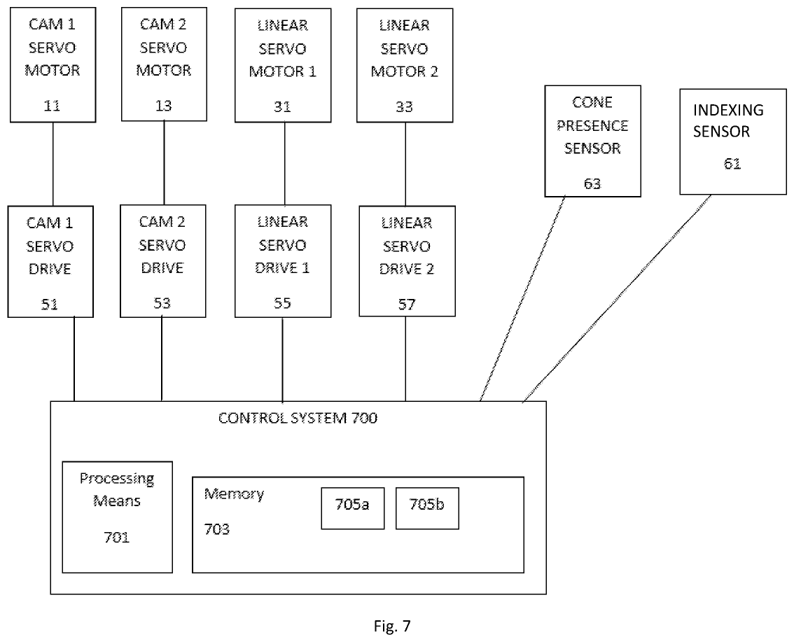

As shown in FIG. 7, the dispensing apparatus of the present disclosure can have a control system 700 that can be communicatively coupled to the various components of the apparatus. The cam motors 11, 13 and linear motors 31,33 can further be communicatively coupled to drives, which can be located inside the electrical enclosure and separate from the motors. All of the motors can have built in encoders to prevent the need for any position sensors. Other exemplary embodiments can utilize additional sensor to monitor position of the motors. In one exemplary embodiment, a first cam servo drive 51 can be communicatively coupled to a first cam servo motor 11 and a second cam servo drive 53 can be communicatively coupled to a second cam servo motor 13.

Similarly, a first linear motor 31 can be communicatively coupled to a first linear servo drive 55 and a second linear servo drive 57 can be communicatively coupled to a second linear motor 33. In some exemplary embodiments, the control system 700 can be communicatively coupled to each of the drives and motors. Alternatively, the motors and drives can be incorporated to a singular motor assembly that can be communicatively coupled to the control system. The control system can have a computing means 701, memory 703, and one or more programs 705 or algorithms stored on the memory to execute the dispensing cycles of the dispensing apparatus. A user can first input one or more parameters, including cone size and dispensing speed (cycles per minute).

In some exemplary embodiments, the control system can be a logic controller or any other suitable means such as a computer and can include a processing means 701, memory 703 for storing pre-determined programs, and communicatively coupled to the various servo motors and/or sensors of the apparatus. The motors can include the linear motors or servo motors used by various assemblies of the apparatus. In some exemplary embodiments, control system 700 can be a logic controller can include a logic program 705, which can be stored on the memory 703. In some exemplary embodiments, the one or more programs 705 be stored on the memory and can allow the apparatus to provide a steady and consistent dispensing of the products/cones 201. A user can first input one or more parameters, including machine speed (cycles per minute) and a wrap cut length.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A cone dispensing apparatus for dispensing a cone, comprising:
a control system;
a first cam and a second cam, wherein the first cam and second cam are positioned parallel to each other in a housing;
a first rotary motor coupled to the first cam and a second rotary motor coupled to the second cam, wherein the first rotary motor is configured to rotate the first cam around a first axis and the second rotary motor is configured to rotate the second cam around a second axis;
a first holdback plate and a second holdback plate;
a first linear motor coupled to the first holdback plate and a second linear motor coupled to the second holdback plate, wherein the first linear motor moves the first holdback plate alone a third axis and the second linear motor moves the second holdback plate along a fourth axis,
wherein the first rotary motor, second rotary motor, first linear motor, and second linear motor are communicatively coupled to the control system.

2. The apparatus of claim 1, wherein each cam includes a plurality of cone dispensing portion, wherein each cone dispensing portion comprise a cone receiver portion and a cone separator portion, wherein the cone receiver portion receives a cone released from a cone stack.

3. The apparatus of claim 2, wherein the cone dispensing portion further includes a cone sweep portion.

4. The apparatus of claim 3, further comprising a first cam sensor proximate to the first cam and a second cam sensor proximate to the second cam, wherein each cam sensor is configured to monitor the positioning of the cams rotation around the axis respective to the other cam, wherein the cam sensors are communicatively coupled to the control system.

5. The apparatus of claim 4, wherein the holdback plates further comprise one or more finger portions, wherein the finger portions are configured to engage a cone on the cone stack.

6. The apparatus of claim 5, wherein receiver portion of the cams can be rotate from a first position and a second position.

7. The cone dispensing apparatus of claim 6, wherein the hold back plates can be moved by the respective linear motors from a first position to a second position, wherein the first position can be an open position and the second position can be closed position.

8. The apparatus of claim 1, wherein the third and fourth axis are horizontal.

9. The apparatus of claim 1, wherein the first cam has a first cone dispensing portion and a second cone dispensing portion, wherein the first cone dispensing portion is positioned on the opposite side of the second cone dispensing portion.

10. The apparatus of claim 9, wherein the second cam has a third cone dispensing portion and the fourth cone dispensing portion, wherein the third cone dispensing portion is positioned on the opposite side of the fourth cone dispensing portion.

11. The apparatus of claim 10, wherein at the distal end of the finger portion, the plates can have a grip portion configured to interface with the cones of the respective cone stack.

12. The apparatus of claim 1, wherein the first cam has a first set of cone dispensing portions on a first side of the first cam and a second set of cone dispensing portions on a second side of the first cam.

13. The apparatus of claim 13, wherein the second cam has a third set of cone dispensing portions on a first side of the second cam and a third set of cone dispensing portions on a second side of the second cam.

14. The apparatus of claim 14, wherein the first set of dispensing portions of the first cam are configured to be in a first index cycle with the third set of dispensing portions of the second cam, and the second set of dispensing portions of the first cam are configured to be in a second index cycle with the fourth set of dispensing portions of the second cam.

15. A cone dispensing apparatus for dispensing a cone, comprising:
a control system;
a first cam and a second cam, wherein the first cam and second cam are positioned parallel to each other in a housing;
a first motor configured to turn the first cam around a first axis and a second motor configured to turn the second cam around a second axis;
a control system, comprising a processing means, memory for storing one or more pre-determined programs communicatively, wherein the control system is communicatively coupled to the first motor.

16. The cone dispensing apparatus of claim 16, wherein the first cam has a first cone dispensing portion and a second cone dispensing portion, wherein the first cone dispensing portion is positioned on the opposite side of the second cone dispensing portion.

17. The cone dispensing apparatus of claim 15, wherein the control system comprises a processing means and a memory and is communicatively coupled to the first motor and second motor.

18. The cone dispensing apparatus of claim 17, further comprising a first cam indexing sensor positioned proximate to the first cam and second cam indexing sensor positioned proximate to the second cam.

19. The cone dispensing apparatus of claim 18, wherein the first cone indexing sensor and second cone indexing sensor are communicatively coupled to the control system and configured to monitor the position of the first cam to the position of the second cam.

20. The cone dispensing apparatus of claim 19, wherein the first set of dispensing portions of the first cam are configured to be in a first index cycle with the third set of dispensing portions of the second cam, and the second set of dispensing portions of the first cam are configured to be in a second index cycle with the fourth set of dispensing portions of the second cam.
